(19) United States
(12) Patent Application Publication
(10) Pub. No.: US 2010/0218703 A1
(43) Pub. Date: Sep. 2, 2010

(54) OPTICAL VARIABLE EFFECT PIGMENTS

(76) Inventors: Patrice Bujard, Courtepin (CH); Philippe Bugnon, Le Mouret (CH)

Correspondence Address: BASF Performance Products LLC;Patent Department, 540 White Plains Road, P.O. Box 2005, Tarrytown, NY, 10591, US

(21) Appl. No.: 12/670,862

(22) PCT Filed: Jul. 21, 2008
(86) PCT No.: PCT/EP08/59497

§ 371 Date: Jan. 27, 2010

(30) Foreign Application Priority Data
Jul. 31, 2007 (EP) 07113507.3

(51) Int. Cl. C09B 67/22

(52) U.S. Cl. 106/438; 106/401; 106/436; 106/441; 106/442

(57) ABSTRACT

The present invention relates to pigments comprising (A) a platelet-shaped substrate (S), (B) a coating comprising two different metal oxides having a difference in refractive index of at least 0.1, wherein the metal oxide having a higher refractive indexis the metal oxide MOH and the metal oxide having a lower refractive index is the metal oxide MOL, wherein the amount of MOH and the amount of MOL changes (continuously), (C) a coating comprising metal oxides MOH and MOL, wherein the amount of MOH and the amount of MOL changes (continuously), and (D) optionally an outer protecting layer; a process for their production and their use in paints, ink-jet printing, for dyeing textiles, for pigmenting coatings (paints), printing inks, plastics, cosmetics, glazes for ceramics and glass. The pigments can show enhanced colour chroma while maintaining the lightness of coventional interference pigments, or vice versa.

The present invention relates to pigments on basis of platelet-shaped substrates (S), comprising
coating(s) comprising two different metal oxides having a difference in refractive index of at least 0.1, wherein the metal oxide having a higher refractive index is the metal oxide MOH and the metal oxide having a lower refractive index is the metal oxide MOL, wherein the amount of MOH and the amount of MOL is continuously changing,
a process for their production and their use in paints, ink-jet printing, for dyeing textiles, for pigmenting coatings (paints), printing inks, plastics, cosmetics, glazes for ceramics and glass. The pigments can show enhanced colour chroma while maintaining the lightness of coventional interference pigments, or vice versa.

U.S. Pat. No. 6,579,355 relates to a strong interference pigment comprising a multiply-coated platelet-shaped substrate, having at least one layer sequence of (A) a high refractive index coating comprising a mixture of TiO₂ and Fe₂O₃ in a weight ratio of about 10:1 to about 1:3 and optionally one or more metal oxides in amounts of < about 20% by weight based on the layer (A), (B) a colorless coating having a refractive index n<about 1.8, and optionally (C) an outer protective layer.

U.S. Pat. No. 6,692,561 discloses interference pigments comprising a multicoated platelet-shaped substrate having at least one two layer sequence comprising:
(A) a colorless coating having a refractive index, n, of 23 1.8, and
(B) a high-refractive-index coating consisting of a mixture of TiO₂ and Fe₂O₃ in a weight ratio of from 1:0.1 to 1:5, and one or more metal oxides selected from Al₂O₃, Ce₂O₃, ZrO₂, SnO₂ and/or B₂O₃, in an amount up to 20% by weight, based on the total weight of layer (B),
and optionally (C) an outer protective layer.

US2004166316A1 relates to an iridescent pigment comprising a platelet shaped substrate and coated thereon at least two layers of metal oxides, each of said metal oxide layers comprising one or more metals selected from the group consisting of Ce, Sn, Ti, Fe, Zn and Zr.

U.S. Pat. No. 6,482,419 inorganic composite powder comprising: a scaled substrate, and at least three inorganic oxide layers having different refractive indexes respectively and sequentially laminated in an order of high refractive index to low refractive index from a surface of the scaled substrate to an utmost outer layer, wherein a refractive index of an inorganic oxide used for forming the utmost outer layer is 1.73 or less, and a difference in the refractive indexes between the utmost layer and a layer adjacent thereto is 0.6 or less. In example 1 a pigment is described, comprising a mica substrate, which has subsequently been coated with TiO₂, ZrO₂, Al₂O₃ and SiO₂.

U.S. Pat. No. 5,855,660 describes pigments comprising
(a) a flat core and
(b) at least one coating consisting of at least two different substances that is applied to the surface of the core, wherein the coating (b) has a substantially continuously variable composition in the axis lying perpendicular to its surface, and
   the refractive indices of the coating (b) at the surface facing the core (a) and at the surface remote from the core (a) are different.

The composition of the coating (b) is substantially continuously variable in the axis lying perpendicular to its surface. This is to be understood as meaning that the composition of the coating (b) from the surface facing the core (a) to the surface remote from the core (a) either changes continuously or, where appropriate, changes stepwise, in small steps, the composition changing only slightly between two adjacent stages so that the difference in refractive index between two adjacent stages does not cause a significant refraction of light.

In Example 1 of U.S. Pat. No. 5,855,660 a glass plate is coated subsequently with TiO₂, TiO₂/SiO₂ (concentration of TiO₂ decreases continuously and concentration of TiO₂ increases continuously), and SiO₂

In Example 5 of U.S. Pat. No. 5,855,660 a glass plate is coated with six layers of different refractive index:

| | Layer | Composition | | Refractive |
|---|---|---|---|---|
| | thickness | [% by vol.] | | index |
| glass plate | — | — | | 1.5 |
| 1st layer | 20 nm | — | MgF₂ 100% | 1.38 |
| 2nd layer | 43 nm | TiO₂ 6% | MgF₂ 94% | 1.43 |
| 3rd layer | 30 nm | TiO₂ 17% | MgF₂ 83% | 1.52 |
| 4th layer | 25 nm | TiO₂ 40% | MgF₂ 60% | 1.71 |
| 5th layer | 20 nm | TiO₂ 75% | MgF₂ 25% | 1.99 |
| 6th layer | 20 nm | TiO₂ 100% | — | 2.2 |

U.S. Pat. No. 6,482,419 discloses an inorganic composite powder comprising: a scaled substrate, and at least three inorganic oxide layers having different refractive indexes respectively and sequentially laminated in an order of high refractive index to low refractive index from a surface of the scaled substrate to an utmost outer layer, wherein a refractive index of an inorganic oxide used for forming the utmost outer layer is 1.73 or less, and a difference in the refractive indexes between the utmost layer and a layer adjacent thereto is 0.6 or less.

EP1025168 (and EP0948572) discloses interference pigments comprising a multiply coated, platelet-shaped substrate (S) having at least one layer sequence comprising
(A) a coating having a refractive index n≧2.0,
(B) a colourless coating having a refractive index n≦1.8, and
(C) a nonabsorbing coating of high refractive index, and (D) optionally an outer protecting layer.

No actual technology allows manufacturing mica powder featuring a narrow enough thickness distribution. Accordingly, coating of the mica with a metal oxide, like TiO₂, usually does not lead to optical variable colours.

The present invention provides a mean to have both a substrate powder featuring a large thickness distribution and an optical variable colour. It also allows to enhance the colour chroma while keeping the same lightness or vice versa. By using the concept of the present invention pigments having a purer hue can be obtained. It is also possible to produce pigments, which have maximum reflectivity in the NIR region and maximum transmission in the visible region.

Accordingly, the present invention relates to pigments, comprising
(A) a platelet-shaped substrate (S),
(B) a coating comprising two different metal oxides having a difference in refractive index of at least 0.1, wherein the metal oxide having a higher refractive index is the metal oxide MOH and the metal oxide having a lower refractive index is the metal oxide MOL, wherein the amount of MOH and the amount of MOL changes (continuously),
(C) a coating comprising metal oxides MOH and MOL, wherein the amount of MOH and the amount of MOL changes (continuously), and
(D) optionally an outer protecting layer.

The coatings (B) and (C) are manufactured such that there is variation, especially a continuous variation of the local index of refraction (hereafter gradient of index) across the thickness of this coating. That is, the composition of the coatings (B) and (C) changes continuously in the axis lying perpendicular to their surface. This coating with a gradient of index can be combined with metal oxide layers without gradient of index.

Suitable platelet-shaped substrates (S) are transparent, partially reflectant, or reflectant. Examples thereof are natural micaceous iron oxide (for example as in WO99/48634), synthetic and doped micaceous iron oxide (for example as in EP-A-068311), mica (biotite, vermiculite, sericite, muscovite, phlogopite, fluorophlogopite, kaolinite or related, or any synthetic mica, such as synthetic fluorophlogopite), basic lead carbonate, flaky barium sulfate, MoS₂, SiO₂, Al₂O₃, TiO₂, glass, ZnO, ZrO₂, SnO₂, BiOCl, chromium oxide, BN, MgO flakes, Si₃N₄, and graphite. Particularly preferred substrates are mica, synthetic mica, SiO₂ flakes, Al₂O₃ flakes, TiO₂ flakes, and glass flakes.

Another preferred embodiment is the use of flat metallic particles as the core. Examples of suitable metallic particles are flakes of Ag, Al, Au, Cu, Cr, Fe, Ge, Mo, Ni, Si, Ti, or alloys thereof, such as brass or steel, preferably Al flakes. Depending on the material, a natural optically non-interfering oxide layer may form on the surface of metallic particle. Partially reflecting cores have preferably a reflectance of at least 35% of the light falling vertically on its surface in the range from 380 to 800 nm.

Additional examples of plateletlike substrates are plateletlike organic pigments, such as chinacridones, phthalocyanine, fluororubine, red perylenes or diketopyrrolopyrroles.

MOH and MOL can be different in layers (B) and (C), but are preferably the same.

MOH and MOL can be selected from metal oxides having a “high” refractive index, that is to say a refractive index greater than about 1.65, preferably greater than about 2.0, most preferred greater than about 2.2, and from metal oxides having a “low” refractive index, that is to say a refractive index smaller, or equal than about 1.65. Examples of metal oxides having a “high” refractive index are zinc sulfide (ZnS), zinc oxide (ZnO), zirconium oxide (ZrO₂), titanium dioxide (TiO₂), carbon, indium oxide (In₂O₃), indium tin oxide (ITO), tantalum pentoxide (Ta₂O₅), chromium oxide (Cr₂O₃), cerium oxide (CeO₂), yttrium oxide (Y₂O₃), europium oxide (Eu₂O₃), iron oxides such as iron(II)/iron(III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon monoxides (SiO), selenium trioxide (Se₂O₃), tin oxide (SO₂), or tungsten trioxide (WO₃).

Examples of a metal oxide of low refractive index are SiO₂, Al₂O₃, AlOOH, or B₂O₃, with SiO₂, Al₂O₃, and B₂O₃ being especially preferred. MOH and MOL can both be metal oxides having a “high” refractive index, or metal oxides having a “low” refractive index, or MOH is a metal oxide having a “high” refractive index and MOL is a metal oxide having a “low” refractive index, the difference in refractive index of the two metal oxides is at least 0.1.

Preferred metal oxides are TiO₂, SnO₂, ZrO₂, Al₂O₃, SiO₂, MgO, Nb₂O₃, MoO₃, HfO₂, WO₃, CeO₂ and Ta₂O₃. The metal oxide MOL and MOH can be any combination of these materials, as long as the difference in refractive index of the two metal oxides is at least 0.1. The most preferred MOH is (rutile) TiO₂. Most preferred as MOL are Al₂O₃, ZrO₂, and MgO.

The thickness of the coatings (B) and (C) is generally from 10 to 300 nm, preferably from 30 to 150 nm.

In preferred embodiments of the present invention
MOH is TiO₂ and MOL is ZrO₂,
MOH is TiO₂ and MOL is MgO,
MOH is TiO₂ and MOL is Al₂O₃, or
MOH is TiO₂ and MOL is SiO₂.

SnO₂ can be deposited before deposition of TiO₂ to facilitate the formation of the rutile modification.

The above pigments can have an intermediate coating(s) (B1) between coating (B) and (C). The intermediate coating (B1) consists preferably of one of the above-mentioned metal oxides having a “high”, or “low” refractive index, or are a coating consisting of x % by weight MOH and 100-x % by weight of MOL, wherein x is 0 to 90% by weight.

The intermediate coating (B1) has a thickness of from 10 to 300 nm, preferably from 30 to 150 nm.

In addition, an intermediate coating(s) (S1) can be arranged between the substrate (S) and the coating (B) and an additional coating(s) (C1) can be present between the coating (C) and the optional protective coating (D). The coatings (S1) and (C1) consist preferably of one of the above-mentioned metal oxides having a “high”, or “low” refractive index. The coatings (S1) and (C1) have a thickness of from 10 to 300 nm, preferably from 30 to 150 nm.

The above pigments can comprise one layer sequence (B) and (C), but they can also comprise multiple layer sequences [(B) and (C)]ₙ, wherein n is preferably an integer 1 to 5, most preferably 1, or 2, or [(B) and (C) and (B)], or [(B) and (C) and (B) and (C) and (B)].

In a preferred embodiment the present invention is directed to pigments, comprising
(A) a platelet-shaped substrate (S),
(B) a coating comprising two different metal oxides having a difference in refractive index of at least 0.1, wherein the metal oxide having a higher refractive index is the metal oxide MOH and the metal oxide having a lower refractive index is the metal oxide MOL,
(b1) the amount of MOH is 100% by weight on the side next to the substrate, the amount of MOL is 0% by weight on the side next to the substrate, and the amount of MOH and MOL changes continuously until the amount of MOH is x % by weight and the amount of MOL is 100-x % by weight, or
(b2) the amount of MOH is x % by weight on the side next to the substrate, the amount of MOL is 100-x % by weight on the side next to the substrate, and the amount of MOH and MOL changes continuously until the amount of MOH is 100% by weight and the amount of MOL is 0% by weight,
(C) a coating comprising metal oxides MOH and MOL, wherein in case (b1)
(c1) the amount of MOH is x % by weight next to coating (B), the amount of MOL is 100-x % by weight next to the coating (B), and the amount of MOH and MOL changes continuously until the amount of MOH is 100% by weight and the amount of MOL is 0% by weight, or
(c1′) the amount of MOH is 100% by weight next to coating (B), the amount of MOL is 0% by weight next to the coating (B), and the amount of MOH and MOL changes continuously until the amount of MOH is x % by weight and the amount of MOL is 100-x % by weight, or in case (b2)
(c2) the amount of MOH is 100% by weight next to coating (B), the amount of MOL is 0% by weight next to the coating (B), and the amount of MOH and MOL changes continuously until the amount of MOH is x % by weight and the amount of MOL is 100-x % by weight, or
(c2′) the amount of MOH is x % by weight next to coating (B), the amount of MOL is 100-x % by weight next to the coating (B), and the amount of MOH and MOL changes continuously until the amount of MOH is 100% by weight and the amount of MOL is 0% by weight, and
(D) optionally an outer protecting layer, wherein x is 0 to 90% by weight.

The above preferred embodiment will be explained in more detail below on basis of TiO₂ as MOH and Al₂O₃ as MOL, but is not limited thereto.

In the first alternative of the preferred embodiment the pigments comprise
(A) a platelet-shaped substrate (S),
(B) a coating comprising MOH and MOL,
(b1) the amount of MOH is 100% by weight on the side next to the substrate, the amount of MOL is 0% by weight on the side next to the substrate, and the amount of MOH and MOL changes continuously until the amount of MOH is x % by weight and the amount of MOL is 100-x % by weight,
(B1) optionally a coating consisting of 100-x % by weight MOL and x % by weight MOH, or MOH,
(C) a coating comprising components MOH and MOL, wherein
(c1) the amount of MOH is x % by weight next to coating (B), the amount of MOL is 100-x % by weight next to the coating (B), and the amount of MOH and MOL changes continuously until the amount of MOH is 100% by weight and the amount of MOL is 0% by weight, and
(D) optionally an outer protecting layer, wherein x is 0 to 90% by weight.

In case of TiO₂ as MOH and Al₂O₃ as MOL x is preferably 70% by weight. Accordingly, the pigments will have the following structure:

| | |
|---|---|
| Substrate: | a platelet-shaped substrate (S) |
| 1. Coating [(Bb1)] | TiO₂ (100% by weight) → TiO₂ (70% by weight) |
| | Al₂O₃ (0% by weight) → Al₂O₃ (30% by weight) |
| 2. Coating [(Cc1)] | TiO₂ (70% by weight) → TiO₂ (100% by weight) |
| | Al₂O₃ (30% by weight) → Al₂O₃ (0% by weight) |

The above pigments can have an intermediate coating(s) (B1) between coating (Bb1) and (Cc1). The intermediate coating (B1) consists preferably of 70% by weight TiO₂ and 30% by weight of Al₂O₃, or a layer of TiO₂.

An intermediate coating (S1) can be arranged between the substrate (S) and the coating (B) and an additional coating(s) (C1) can be present between the coating (C) and the optional protective coating (D). The coatings (S1) and (C1) consist preferably of TiO₂.

In said embodiment preferred pigments have the following layer structure:
Substrate (S), coating (Bb1), coating (Cc1)
Substrate (S), coating (Bb1), coating (B1m), coating (Cc1)
Substrate (S), (SnO₂) TiO₂, coating (Bb1), coating (Cc1), (SnO₂) TiO₂
Substrate (S), (SnO₂) TiO₂, coating (Bb1), coating (B1 m), coating (Cc1), (SnO₂) TiO₂
Substrate (S), (SnO₂) TiO₂, coating (Bb1), TiO₂, coating (Cc1), (SnO₂) TiO₂
Substrate (S), coating (Bb1), coating (Cc1), coating (Bb1), coating (Cc1)
Substrate (S), (SnO₂) TiO₂, coating (Bb1), coating (Cc1), coating (Bb1), coating (Cc1), (SnO₂) TiO₂.

The coating (B1 m) consists of 100-x % by weight MOL and x % by weight MOH. The coating (B1 H) consists of MOH. The coating (B1 m) consists preferably of 70% by weight TiO₂ and 30% by weight of Al₂O₃. The coating (B1 H) consists preferably of TiO₂.

In an alternative preferred embodiment x is preferably 100% by weight. Accordingly, the pigments will have the following structure:

| | |
|---|---|
| Substrate: | a platelet-shaped substrate (S) |
| 1. Coating [(Bb1)] | TiO₂ (100% by weight) → TiO₂ (0% by weight) |
| | Al₂O₃ (0% by weight) → Al₂O₃ (100% by weight) |
| 2. Coating [(Cc1)] | TiO₂ (0% by weight) → TiO₂ (100% by weight) |
| | Al₂O₃ (100% by weight) → Al₂O₃ (0% by weight) |

In the second alternative of the preferred embodiment the pigments comprise
(A) a platelet-shaped substrate (S),
(B) a coating comprising MOH and MOL,
(b2) the amount of MOH is x % by weight on the side next to the substrate, the amount of MOL is 100-x % by weight on the side next to the substrate, and the amount of MOH and MOL changes continuously until the amount of MOH is 100% by weight and the amount of MOL is 0% by weight,
(B1) optionally a coating consisting of MOH, or 100-x % by weight MOL and x % by weight MOH,
(C) a coating comprising MOH and MOL, wherein
(c2) the amount of MOH is 100% by weight next to coating (B), the amount of MOL is 0% by weight next to the coating (B), and the amount of MOH and MOL changes continuously until the amount of MOH is x % by weight and the amount of MOL is 100-x % by weight, and
(D) optionally an outer protecting layer, wherein x is 0 to 90% by weight.

In case of TiO₂ as MOH and Al₂O₃ as MOL x is preferably 70% by weight. Accordingly, the pigments will have the following structure:

| | |
|---|---|
| Substrate: | a platelet-shaped substrate (S) |
| 1. Coating [(Bb2)] | TiO₂ (70% by weight) → TiO₂ (100% by weight) |
| | Al₂O₃ (30% by weight) → Al₂O₃ (0% by weight) |
| 2. Coating [(Cc2)] | TiO₂ (100% by weight) → TiO₂ (70% by weight) |
| | Al₂O₃ (0% by weight) → Al₂O₃ (30% by weight) |

The above pigments can have an intermediate coating(s) (B1) between coating (Bb2) and (Cc2). The intermediate coating (B1) consists preferably of TiO₂, or a layer of 70% by weight TiO₂ and 30% by weight of Al₂O₃.

An intermediate coating (S1) can be arranged between the substrate (S) and the coating (B) and an additional coating(s) (C1) can be present between the coating (C) and the optional protective coating (D). The coatings S1 and C1 consist preferably of TiO₂.

In said embodiment preferred pigments have the following layer structure:
Substrate (S), coating (Bb2), coating (Cc2)
Substrate (S), coating (Bb2), coating (B1H), coating (Cc2)
Substrate (S), coating (Bb2), coating (B1m), coating (Cc2)
Substrate (S), (SnO₂) TiO₂, coating (Bb2), coating (Cc2), (SnO₂) TiO₂
Substrate (S), (SnO₂) TiO₂, coating (Bb2), coating (B1H), coating (Cc2), (SnO₂) TiO₂
Substrate (S), (SnO₂) TiO₂, coating (Bb2), coating (B1H), coating (Cc2), (SnO₂) TiO₂
Substrate (S), coating (Bb2), coating (Cc2), coating (Bb2), coating (Cc2)
Substrate (S), (SnO₂) TiO₂, coating (Bb2), coating (Cc2), coating (Bb2), coating (Cc2), (SnO₂) TiO₂.

In the third alternative of the preferred embodiment the pigments comprise
(A) a platelet-shaped substrate (S),
(B) a coating comprising MOH and MOL,
(b1) the amount of MOH is 100% by weight on the side next to the substrate, the amount of MOL is 0% by weight on the side next to the substrate, and the amount of MOH and MOL changes continuously until the amount of MOH is x % by weight and the amount of MOL is 100-x % by weight,
(B1) optionally a coating consisting of 100-x % by weight MOL and x % by weight MOH, or MOH,
(C) a coating comprising metal oxides MOH and MOL, wherein
(c2) the amount of MOH is 100% by weight next to coating (B), the amount of MOL is 0% by weight next to the coating (B), and the amount of MOH and MOL changes continuously until the amount of MOH is x % by weight and the amount of MOL is 100-x % by weight, and
(D) optionally an outer protecting layer, wherein x is 0 to 90% by weight.

In case of TiO₂ as MOH and Al₂O₃ as MOL x is preferably 70% by weight. Accordingly, the pigments will have the following structure:

| | |
|---|---|
| Substrate: | A platelet-shaped substrate (S) |
| 1. Coating [(Bb2)] | TiO₂ (70% by weight) → TiO₂ (100% by weight) |
| | Al₂O₃ (30% by weight) → Al₂O₃ (0% by weight) |
| 2. Coating [(Cc2)] | TiO₂ (100% by weight) → TiO₂ (70% by weight) |
| | Al₂O₃ (0% by weight) → Al₂O₃ (30% by weight) |

The above pigments can have an intermediate coating(s) (B1) between coating (Bb2) and (Cc2). The intermediate coating (B1) consists preferably of 70% by weight TiO₂ and 30% by weight of Al₂O₃, or a layer of TiO₂.

An intermediate coating (S1) can be arranged between the substrate (S) and the coating (B) and an additional coating(s) (C1) can be present between the coating (C) and the optional protective coating (D). The coating S1 consists preferably of TiO₂and the coating C1 consists preferably of Al₂O₃.

In said embodiment preferred pigments have the following layer structure:
Substrate (S), coating (Bb1), coating (Cc2)
Substrate (S), coating (Bb1), coating (B1m), coating (Cc2)
Substrate (S), coating (Bb1), coating (B1H), coating (Cc2)
Substrate (S), (SnO₂) TiO₂, coating (Bb1), coating (Cc2), Al₂O₃
Substrate (S), (SnO₂) TiO₂, coating (Bb1), coating (B1m), coating (Cc2), Al₂O₃
Substrate (S), (SnO₂) TiO₂, coating (Bb1), coating (B1H), coating (Cc2), Al₂O₃
Substrate (S), coating (Bb1), coating (Cc2), coating (Bb1), coating (Cc2)
Substrate (S), (SnO₂) TiO₂, coating (Bb1), coating (Cc2), coating (Bb1), coating (Cc2), Al₂O₃

In the fourth alternative of the preferred embodiment the pigments comprise
(A) a platelet-shaped substrate (S),
(B) a coating comprising MOH and MOL,
(b2) the amount of MOH is x % by weight on the side next to the substrate, the amount of MOL is 100-x % by weight on the side next to the substrate, and the amount of MOH and MOL changes continuously until the amount of MOH is 100% by weight and the amount of MOL is 0% by weight,
(B1) optionally a coating consisting of 100-x % by weight MOL and x % by weight MOH, or MOH,
(C) a coating comprising components MOH and MOL, wherein
(c2′) the amount of MOH is x % by weight next to coating (B), the amount of MOL is 100-x % by weight next to the coating (B), and the amount of MOH and MOL changes continuously until the amount of MOH is 100% by weight and the amount of MOL is 0% by weight, and
(D) optionally an outer protecting layer, wherein x is 0 to 90% by weight.

In case of TiO₂ as MOH and Al₂O₃ as MOL x is preferably 70% by weight. Accordingly, the pigments will have the following structure:

| | |
|---|---|
| Substrate: | A platelet-shaped substrate (S) |
| 1. Coating [(Bb2)] | TiO₂ (70% by weight) → TiO₂ (100% by weight) |
| | Al₂O₃ (30% by weight) → Al₂O₃ (0% by weight) |
| 2. Coating [(Cc2′)] | TiO₂ (70% by weight) → TiO₂ (100% by weight) |
| | Al₂O₃ (30% by weight) → Al₂O₃ (0% by weight) |

The above pigments can have an intermediate coating(s) (B1) between coating (Bb2) and (Cc2′). The intermediate coating (B1) consists preferably of TiO₂.

An intermediate coating (S1) can be arranged between the substrate (S) and the coating (B) and an additional coating(s) (C1) can be present between the coating (C) and the optional protective coating (D). The coating S1 consists preferably of TiO₂ and the coating C1 consists preferably of TiO₂, or a layer of 70% by weight TiO₂ and 30% by weight of Al₂O₃

In said embodiment preferred pigments have the following layer structure:
Substrate (S), coating (Bb2), coating (Cc2′)
Substrate (S), coating (Bb2), coating (B1 m), coating (Cc2′)
Substrate (S), coating (Bb2), coating (B1 H), coating (Cc2′)
Substrate (S), (SnO₂) TiO₂, coating (Bb2), coating (Cc2′), (SnO₂) TiO₂
Substrate (S), (SnO₂) TiO₂, coating (Bb2), coating (B1 m), coating (Cc2′), (SnO₂) TiO₂
Substrate (S), (SnO₂) TiO₂, coating (Bb2), coating (B1H), coating (Cc2′), (SnO₂) TiO₂
Substrate (S), coating (Bb2), coating (Cc2′), coating (Bb2), coating (Cc2′)
Substrate (S), (SnO₂) TiO₂, coating (Bb2), coating (Cc2′), coating (Bb2), coating (Cc2′), (SnO₂) TiO₂.

In said embodiment a pigment having the layer structure below is especially preferred: Substrate (=mica, Al₂O₃, SiO₂, glass), (SnO₂) TiO₂ (30 nm), coating (Bb2) (50 nm), coating (Cc1) (50 nm), (SnO₂) TiO₂ (30 nm). Said pigment is characterized by a high chroma.

In another preferred embodiment of the present invention case TiO₂ is used as MOH and Al₂O₃ is used as MOL and x is preferably 0% by weight. Accordingly, the pigments will have the followina structure:

| | |
|---|---|
| Substrate: | A platelet-shaped substrate (S) |
| 1. Coating | TiO₂ |
| 2. Coating | TiO₂ (100% by weight) → TiO₂ (0% by weight) |
| | Al₂O₃ (0% by weight) → Al₂O₃ (100% by weight) |
| 3. Coating | TiO₂ |
| 4. Coating | TiO₂ (100% by weight) → TiO₂ (0% by weight) |
| | Al₂O₃ (0% by weight) → Al₂O₃ (100% by weight) |
| 5. Coating | TiO₂ |

The metal oxide layers can be applied by PVD (physical vapour deposition), (CVD (chemical vapour deposition) or by wet chemical coating. The metal oxide layers can be obtained by decomposition of metal carbonyls in the presence of water vapour (relatively low molecular weight metal oxides such as magnetite) or in the presence of oxygen and, where appropriate, water vapour (e.g. nickel oxide and cobalt oxide).

Layers of the metal oxides are preferably applied by precipitation by a wet chemical method. In the case of the wet chemical coating, the wet chemical coating methods developed for the production of pearlescent pigments may be used; these are described, for example, in DE-A-14 67 468, DE-A-19 59 988, DE-A-20 09 566, DE-A-22 14 545, DE-A-22 15 191, DE-A-22 44 298, DE-A-23 13 331, DE-A-25 22 572, DE-A-31 37 808, DE-A-31 37 809, DE-A-31 51 343, DE-A-31 51 354, DE-A-31 51 355, DE-A-32 11 602 and DE-A-32 35 017, DE 195 99 88, WO 93/08237, WO 98/53001 and WO03/6558.

For the purpose of coating, the substrate particles are suspended in water and one or more hydrolysable metal salts are added at a pH suitable for the hydrolysis, which is so selected that the metal oxides or metal oxide hydrates are precipitated directly onto the particles without subsidiary precipitation occurring. The pH is usually kept constant by simultaneously metering in a base. The pigments are then separated off, washed, dried and, where appropriate, calcinated, it being possible to optimise the calcinating temperature with respect to the coating in question. If desired, after individual coatings have been applied, the pigments can be separated off, dried and, where appropriate, calcinated, and then again re-suspended for the purpose of precipitating further layers.

The metal oxide layers are also obtainable, for example, in analogy to a method described in

DE-A-195 01 307, by producing the metal oxide layer by controlled hydrolysis of one or more metal acid esters, where appropriate in the presence of an organic solvent and a basic catalyst, by means of a sol-gel process. Suitable basic catalysts are, for example, amines, such as triethylamine, ethylenediamine, tributylamine, dimethylethanolamine and methoxy-propylamine. The organic solvent is a water-miscible organic solvent such as a C₁₋₄alcohol, especially isopropanol.

Suitable metal acid esters are selected from alkyl and aryl alcoholates, carboxylates, and carboxyl-radical- or alkyl-radical- or aryl-radical-substituted alkyl alcoholates or carboxylates of vanadium, titanium, zirconium, silicon, aluminium and boron. The use of triisopropyl aluminate, tetraisopropyl titanate, tetraisopropyl zirconate, tetraethyl orthosilicate and triethyl borate is preferred. In addition, acetylacetonates and acetoacetylacetonates of the afore-mentioned metals may be used. Preferred examples of that type of metal acid ester are zirconium acetylacetonate, aluminium acetylacetonate, titanium acetylacetonate and diisobutyloleyl acetoacetylaluminate or diisopropyloleyl acetoacetylacetonate.

It is preferred to manufacture the pigment in a single batch using wet chemical coating technologies with or without the help of microwave radiation. Reference is made to US2005013934 with respect to microwave assisted deposition technologies. Depending on the choice of the metal oxide, the use of a chelating agent (for example an amino acid, such as glycine) is required. Reference is made to PCT/EP2008/051910.

The pigments of the present invention comprise a coating comprising two different metal oxides having a difference in refractive index of at least 0.1, wherein the metal oxide having a higher refractive index is the metal oxide MOH and the metal oxide having a lower refractive index is the metal oxide MOL, wherein the amount of MOH and the amount of MOL changes (continuously).

Accordingly, the process for producing the (interference) pigments according to the present invention comprises
(b′) adding a preparation comprising a water-soluble metal compound (MOH′) and distilled water (preparation (A)) slowly while keeping the pH constant by continuous addition of 1M NaOH solution to a suspension of the material being coated, which suspension has been heated to about 50-100° C., wherein the amount of MOH′ is controlled in such a manner, that a coating results, wherein the amount of MOH changes (continuously), and
(b″) simultaneously adding a preparation comprising a water-soluble metal compound (MOL′) and distilled water (preparation (B)) to the suspension, wherein the amount of MOL′ is controlled in such a manner, that a coating results, wherein the amount of MOL changes (continuously), and optionally (c′) adding a preparation comprising a water-soluble metal compound (MOH′) and distilled water (preparation (A)) slowly while keeping the pH constant by continuous addition of 1M NaOH solution to a suspension of the material being coated, which suspension has been heated to about 50-100° C., wherein the amount of MOH′ is controlled in such a manner, that a coating results, wherein the amount of MOH changes (continuously), and
(c″) simultaneously adding a preparation comprising a water-soluble metal compound (MOL′) and distilled water (preparation (B)) to the suspension, wherein the amount of MOL′ is controlled in such a manner, that a coating results, wherein the amount of MOL changes (continuously),

In contrast to U.S. Pat. No. 5,855,660, where the continuously variable coating is produced by chemical vapour deposition, the continuously variable coatings of the present invention are done by wet chemical methods.

The process for the production of said coating (B) and (C) depends on the specific combinations of metal oxides used and is explained in more detail on the basis of TiO₂ (MOH) and Al₂O₃ (MOL), but is not limited thereto.

The pH is set to about 3.5 to 3.7 and a preparation comprising TiOCl₂, HCl, glycine (preparation (A)) and distilled water is added slowly to a suspension of the material being coated at a speed decreasing from 1 to 0 ml/minute within 3 hours, while keeping the pH constant (3.5 to 3.7) by continuous addition of 1M NaOH solution. Simultaneously, a preparation comprising AlCl₃ and distilled water (preparation (B)) is added to the suspension at a speed increasing from 0 to 1 ml/minute within the same time of 3 hours. The pH is kept at 3.5 to 3.7, especially 3.6 with 1M NaOH during the whole process.

The preparations are added to a suspension of the material being coated, which suspension has been heated to about 50-100° C., especially 70-90° C., and maintaining a substantially constant pH value of about from 3.5 to 3.8, especially about 3.6, by simultaneously metering in a base such as, for example, aqueous ammonia solution or aqueous alkali metal hydroxide solution. As soon as the desired layer thickness of precipitated coating has been achieved, the addition of preparation (A) and (B) and base is stopped.

In case an additional TiO₂ layer should be deposited after the gradient coating, it has been proven advantageously to increase the pH first to about 6.0, before going to a pH of 1.8, because the gradient coating might be redissolved, if the pH is decreased directly from 3.6 to 1.8.

Additional layers can be arranged between the platelet-shaped substrate (S), layer (B), (C) and (D). Such an additional layer can consist of TiO₂. The method described in U.S. Pat. No. 3,553,001 being used, in accordance with an embodiment of the present invention, for application of the titanium dioxide layers. An aqueous titanium salt solution is slowly added to a suspension of the material being coated, which suspension has been heated to about 50-100° C., especially 70-80° C., and a substantially constant pH value of about from 0.5 to 5, especially about from 1.2 to 2.5, is maintained by simultaneously metering in a base such as, for example, aqueous ammonia solution or aqueous alkali metal hydroxide solution. As soon as the desired layer thickness of precipitated TiO₂ has been achieved, the addition of titanium salt solution and base is stopped. In principle, the anatase form of TiO₂ forms on the surface of the starting pigment. By adding small amounts of SnO₂, however, it is possible to force the rutile structure to be formed.

For example, as described in WO 93/08237, tin dioxide can be deposited before titanium dioxide precipitation and the product coated with titanium dioxide can be calcined at from 800 to 900° C.

The TiO₂ can optionally be reduced by usual procedures: U.S. Pat. No. 4,948,631 (NH₃, 750-850° C.), WO93/19131 (H₂, >900° C.) or DE-A-19843014 (solid reduction agent, such as, for example, silicon, >600° C.).

In an especially preferred embodiment of the present invention a TiO₂ layer can be formed as described in PCT/EP2008/051910. The flakes to be coated are mixed with distilled water in a closed reactor and heated at about 90° C. The pH is set to about 1.8 to 2.2 and a preparation comprising TiOCl₂, HCl, glycine and distilled water is added slowly while keeping the pH constant (1.8 to 2.2) by continuous addition of 1M NaOH solution. By adding an amino acid, such as glycine, during the deposition of the TiO₂ it is possible to improve the quality of the TiO₂ coating to be formed. Advantageously, a preparation comprising TiOCl₂, HCl, and glycine and distilled water is added to the substrate flakes in water.

If the pigments of the present invention comprise a mixed layer of Al₂O₃/TiO₂, wherein the mixed layer contains up to 30 mol % Al₂O₃, the mixed layer of Al₂O₃/TiO₂ can be obtained by slowly adding an aqueous aluminum and titanium salt solution to a suspension of the material being coated, which suspension has been heated to about 50-100° C., especially 70-90° C., and maintaining a substantially constant pH value of about from 0.5 to 5, by simultaneously metering in a base such as, for example, aqueous ammonia solution or aqueous alkali metal hydroxide solution. As soon as the desired layer thickness of precipitated Al₂O₃/TiO₂ has been achieved, the addition of titanium and aluminum salt solution and base is stopped.

To enhance the weather and light stability the pigments of the present invention can be, depending on the field of application, subjected to a surface treatment. Useful surface treatments are, for example, described in DE-A-2215191, DE-A-3151354, DE-A-3235017, DE-A-3334598, DE-A-4030727, EP-A-649886, WO97/29059, WO99/57204, U.S. Pat. No. 5,759,255, WO2006021388 and PCT/EP2007/062780. Said surface treatment might also facilitate the handling of the pigment, especially its incorporation into various application media.

Usually the protective layer comprises a metal oxide layer of the elements Si, Ce, Al, Zr, Sn, Zn, Mn, Co, Cr, Mo, Sb and/or B and an organic chemical surface modification being applied to the metal oxide layer. The organic chemical surface modification is composed preferably of one or more organofunctional silanes, aluminates, zirconates, titanates etc. The term “metal oxide layer” includes hydroxide layers and/or hydrated oxide layers of the aforementioned elements.

The (effect) pigments according to the invention can be used for all customary purposes, for example for colouring polymers in the mass, coatings (including effect finishes, including those for the automotive sector) and printing inks (including offset printing, intaglio printing, bronzing and flexographic printing), and also, for example, for applications in cosmetics, in ink-jet printing, for dyeing textiles, glazes for ceramics and glass as well as laser marking of papers and plastics. Such applications are known from reference works, for example “High Performance Pigments” (H. M. Smith, Wiley VCH-Verlag GmbH, Weinheim, 2002), “Special effect pigments” (R. Glausch et al., Curt R. Vincentz Verlag, Hannover, 1998). When the pigments according to the invention are interference pigments (effect pigments), they may be goniochromatic and result in brilliant, highly saturated (lustrous) colours. They are accordingly very especially suitable for combination with conventional, transparent pigments, for example organic pigments such as, for example, diketopyrrolopyrroles, quinacridones, dioxazines, perylenes, isoindolinones etc., it being possible for the transparent pigment to have a similar colour to the effect pigment. Especially interesting combination effects are obtained, however, in analogy to, for example, EP-A-388 932 or EP-A-402 943, when the colour of the transparent pigment and that of the effect pigment are complementary.

Accordingly, the present invention is also directed to the use of the pigments of the present invention in paints, ink-jet printing, for dyeing textiles, for pigmenting coatings, printing inks, plastics, cosmetics, glazes for ceramics and glass and paints, printing inks, plastics, cosmetics, ceramics and glass, which are pigmented with a pigment according to the present invention.

The (effect) pigments according to the invention can be added in any tinctorially effective amount to the high molecular weight organic material being pigmented. A pigmented substance composition comprising a high molecular weight organic material and from 0.01 to 80% by weight, preferably from 0.1 to 30% by weight, based on the high molecular weight organic material, of an pigment according to the invention is advantageous. Concentrations of from 1 to 20% by weight, especially of about 10% by weight, can often be used in practice.

High concentrations, for example those above 30% by weight, are usually in the form of concentrates (“masterbatches”) which can be used as colorants for producing pigmented materials having a relatively low pigment content, the pigments according to the invention having an extraordinarily low viscosity in customary formulations so that they can still be processed well.

For the purpose of pigmenting organic materials, the effect pigments according to the invention may be used singly. It is, however, also possible, in order to achieve different hues or colour effects, to add any desired amounts of other colour-imparting constituents, such as white, coloured, black or effect pigments, to the high molecular weight organic substances in addition to the effect pigments according to the invention. When coloured pigments are used in admixture with the effect pigments according to the invention, the total amount is preferably from 0.1 to 10% by weight, based on the high molecular weight organic material. Especially high goniochromicity is provided by the preferred combination of an effect pigment according to the invention with a coloured pigment of another colour, especially of a complementary colour, with colorations made using the effect pigment and colorations made using the coloured pigment having, at a measurement angle of 10°, a difference in hue (H*) of from 20 to 340, especially from 150 to 210.

The pigmenting of high molecular weight organic substances with the pigments according to the invention is carried out, for example, by admixing such a pigment, where appropriate in the form of a masterbatch, with the substrates using roll mills or mixing or grinding apparatuses. The pigmented material is then brought into the desired final form using methods known per se, such as calendering, compression moulding, extrusion, coating, pouring or injection moulding. Any additives customary in the plastics industry, such as plasticisers, fillers or stabilisers, can be added to the polymer, in customary amounts, before or after incorporation of the pigment. In particular, in order to produce non-rigid shaped articles or to reduce their brittleness, it is desirable to add plasticisers, for example esters of phosphoric acid, phthalic acid or sebacic acid, to the high molecular weight compounds prior to shaping.

For pigmenting coatings and printing inks, the high molecular weight organic materials and the effect pigments according to the invention, where appropriate together with customary additives such as, for example, fillers, other pigments, siccatives or plasticisers, are finely dispersed or dissolved in the same organic solvent or solvent mixture, it being possible for the individual components to be dissolved or dispersed separately or for a number of components to be dissolved or dispersed together, and only thereafter for all the components to be brought together.

Dispersing an effect pigment according to the invention in the high molecular weight organic material being pigmented, and processing a pigment composition according to the invention, are preferably carried out subject to conditions under which only relatively weak shear forces occur so that the effect pigment is not broken up into smaller portions.

Plastics comprising the pigment of the invention in amounts of 0.1 to 50% by weight, in particular 0.5 to 7% by weight. In the coating sector, the pigments of the invention are employed in amounts of 0.1 to 10% by weight. In the pigmentation of binder systems, for example for paints and printing inks for intaglio, offset or screen printing, the pigment is incorporated into the printing ink in amounts of 0.1 to 50% by weight, preferably 5 to 30% by weight and in particular 8 to 15% by weight.

The effect pigments according to the invention are also suitable for making-up the lips or the skin and for colouring the hair or the nails.

The invention accordingly relates also to a cosmetic preparation or formulation comprising from 0.0001 to 90% by weight of a pigment, especially an effect pigment, according to the invention and from 10 to 99.9999% of a cosmetically suitable carrier material, based on the total weight of the cosmetic preparation or formulation.

Such cosmetic preparations or formulations are, for example, lipsticks, blushers, foundations, nail varnishes and hair shampoos.

The pigments may be used singly or in the form of mixtures. It is, in addition, possible to use pigments according to the invention together with other pigments and/or colorants, for example in combinations as described hereinbefore or as known in cosmetic preparations. The cosmetic preparations and formulations according to the invention preferably contain the pigment according to the invention in an amount from 0.005 to 50% by weight, based on the total weight of the preparation.

Suitable carrier materials for the cosmetic preparations and formulations according to the invention include the customary materials used in such compositions.

The cosmetic preparations and formulations according to the invention may be in the form of, for example, sticks, ointments, creams, emulsions, suspensions, dispersions, powders or solutions. They are, for example, lipsticks, mascara preparations, blushers, eye-shadows, foundations, eyeliners, powder or nail varnishes.

The cosmetic preparations and formulations according to the invention are prepared in conventional manner, for example by mixing or stirring the components together, optionally with heating so that the mixtures melt.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

### Example 1

20 g of delaminated natural mica (particle size 10-60 microns, thickness 200 to 600 nm) are suspended in 300 ml deionised water. The suspension is heated up to 90° C. and the pH is set to 1.8.

A preparation comprising 34 g of TiOCl₂, 32 g of 37% HCl, 10.2 g glycine and 445 g distilled water (preparation (A)) is added to the suspension during 2 hours at 1 ml/minute while keeping the pH at 1.8.

The pH of the suspension is set to 3.6 with 1 M NaOH.

The preparation (A) is added to the suspension such that the dosing speed decreases from 1 ml/minute to 0 ml/minute within 3 hours. Simultaneously, a preparation comprising 12 g of AlCl₃(H₂O) and 200 g distilled water (preparation (B)) is added to the suspension at a speed increasing from 0 to 1 ml/minute within the same time of 3 hours. The pH is kept at 3.6 with 1M NaOH during the whole process.

Then preparation (A) is added to the suspension at a constant speed of 1 ml/minute during 3 hours whiling keeping the pH at 3.6.

The preparation (A) is added to the suspension such that the dosing speed decreased from 1 ml/minute to 0 ml/minute within 3 hours. Simultaneously, a preparation comprising 100 g of preparation (B) (corresponding to 0.64 g aluminium) and 400 g preparation (A) (corresponding to 3.9 g titanium) is added to the suspension at a speed increasing from 0 to 1 ml/minute within the same time of 3 hours. The pH is kept at 3.6 with 1M NaOH during the whole process.

The pH of the suspension is set to 6 by adding 1M NaOH. Then, the pH of the suspension is again set to 1.8 with 1 M HCl. The preparation (A) is added to the suspension during 2 hours at 1 ml/minute while keeping the ph at 1.8. The suspension is then cooled down, filtered and dried. A bright yellow-orange powder is obtained.

1. A pigment comprising
(A) a platelet-shaped substrate (S),
(B) a coating comprising two different metal oxides having a difference in refractive index of at least 0.1, wherein the metal oxide having a higher refractive index is the metal oxide MOH and the metal oxide having a lower refractive index is the metal oxide MOL, wherein the amount of MOH and the amount of MOL varies continuously in the axis lying perpendicular to its surface,
(C) a coating comprising metal oxides MOH and MOL, wherein the amount of MOH and the amount of MOL varies continuously in the axis lying perpendicular to its surface, and
(D) optionally an outer protecting layer.

2. A pigment according to claim 1, comprising
(A) a platelet-shaped substrate (S),
(B) a coating comprising two different metal oxides having a difference in refractive index of at least 0.1, wherein the metal oxide having a higher refractive index is the metal oxide MOH and the metal oxide having a lower refractive index is the metal oxide MOL, wherein
(b1) the amount of MOH is 100% by weight on the side next to the substrate, the amount of MOL is 0% by weight on the side next to the substrate, and the amount of MOH and MOL varies continuously until the amount of MOH is x % by weight and the amount of MOL is 100-x % by weight, or
(b2) the amount of MOH is x % by weight on the side next to the substrate, the amount of MOL is 100-x % by weight on the side next to the substrate, and the amount of MOH and MOL varies continuously until the amount of MOH is 100% by weight and the amount of MOL is 0% by weight,
(C) a coating comprising metal oxides MOH and MOL, wherein in case (b1)
(c1) the amount of MOH is x % by weight next to coating (B), the amount of MOL is 100-x % by weight next to the coating (B), and the amount of MOH and MOL varies continuously until the amount of MOH is 100% by weight and the amount of MOL is 0% by weight, or
(c1′) the amount of MOH is 100% by weight next to coating (B), the amount of MOL is 0% by weight next to the coating (B), and the amount of MOH and MOL varies continuously until the amount of MOH is x % by weight and the amount of MOL is 100-x % by weight, or in case (b2)
(c2) the amount of MOH is 100% by weight next to coating (B), the amount of MOL is 0% by weight next to the coating (B), and the amount of MOH and MOL varies continuously until the amount of MOH is x % by weight and the amount of MOL is 100-x % by weight, or
(c2′) the amount of MOH is x % by weight next to coating (B), the amount of MOL is 100-x % by weight next to the coating (B), and the amount of MOH and MOL varies continuously until the amount of MOH is 100% by weight and the amount of MOL is 0% by weight, and
(D) optionally an outer protecting layer, wherein x is 0 to 90% by weight.

3. The pigment according to claim 2, comprising
(A) a platelet-shaped substrate (S),
(B) a coating comprising MOH and MOL, wherein
(b1) the amount of MOH is 100% by weight on the side next to the substrate, the amount of MOL is 0% by weight on the side next to the substrate, and the amount of MOH and MOL varies continuously until the amount of MOH is x % by weight and the amount of MOL is 100-x % by weight,
(B1) optionally a coating consisting of 100-x % by weight MOL and x % by weight MOH, or MOH,
(C) a coating comprising MOH and MOL, wherein
(c1) the amount of MOH is x % by weight next to coating (B), the amount of MOL is 100-x % by weight next to the coating (B), and the amount of MOH and MOL varies continuously until the amount of MOH is 100% by weight and the amount of MOL is 0% by weight, and
(C1) a coating consisting of MOH, and
(D) optionally an outer protecting layer, wherein x is 0 to 90% by weight.

4. The pigment according to claim 2, comprising
(A) a platelet-shaped substrate (S),
(B) a coating comprising MOH and MOL, wherein
(b2) the amount of MOH is x % by weight on the side next to the substrate, the amount of MOL is 100-x % by weight on the side next to the substrate, and the amount of MOH and MOL varies continuously until the amount of MOH is 100% by weight and the amount of MOL is 0% by weight,
(B1) optionally a coating consisting of MOH, or 100-x % by weight MOL and x % by weight MOH,
(C) a coating comprising MOH and MOL, wherein
(c1) the amount of MOH is 100% by weight next to coating (B1), the amount of MOL is 0% by weight next to the coating (B1), and the amount of MOH and MOL varies continuously until the amount of MOH is x % by weight and the amount of MOL is 100-x % by weight, and
(C1) a coating consisting of MOL, and
(D) optionally an outer protecting layer, wherein x is 0 to 90% by weight.

5. The pigment according to claim 2, comprising
(A) a platelet-shaped substrate (S),
(B) a coating comprising MOH and MOL, wherein
(b1) the amount of MOH is 100% by weight on the side next to the substrate, the amount of MOL is 0% by weight on the side next to the substrate, and the amount of MOH and MOL varies continuously until the amount of MOH is x % by weight and the amount of MOL is 100-x % by weight,
(B1) optionally a coating consisting of 100-x % by weight MOL and x % by weight MOH, or MOH,
(C) a coating comprising metal oxides MOH and MOL, wherein
(c1′) the amount of MOH is 100% by weight next to coating (B), the amount of MOL is 0% by weight next to the coating (B), and the amount of MOH and MOL varies continuously until the amount of MOH is x % by weight and the amount of MOL is 100-x % by weight,
(C1) a coating consisting of MOL, and
(D) optionally an outer protecting layer, wherein x is 0 to 90% by weight.

6. The pigment according to claim 2, comprising
(A) a platelet-shaped substrate (S),
(B) a coating comprising MOH and MOL, wherein
(b2) the amount of MOH is x % by weight on the side next to the substrate, the amount of MOL is 100-x % by weight on the side next to the substrate, and the amount of MOH and MOL varies continuously until the amount of MOH is 100% by weight and the amount of MOL is 0% by weight,
(B1) optionally a coating consisting of MOH,
(C) a coating comprising components MOH and MOL, wherein
(c2′) the amount of MOH is x % by weight next to coating (B), the amount of MOL is 100-x % by weight next to the coating (B), and the amount of MOH and MOL varies continuously until the amount of MOH is 100% by weight and the amount of MOL is 0% by weight, and
(C1) a coating consisting of MOH,
(D) optionally an outer protecting layer, wherein x is 0 to 90% by weight.

7. The pigment according to claim 1, wherein
MOH is TiO₂ and MOL is ZrO₂,
MOH is TiO₂ and MOL is MgO,
MOH is TiO₂ and MOL is Al₂O₃, or
MOH is TiO₂ and MOL is SiO₂.

8. The pigment according to claim 3, wherein the pigment has one of the following layer structures:
Substrate (S), coating (Bb1), coating (Cc1),
Substrate (S), coating (Bb1), coating (B1m), coating (Cc1),
Substrate (S), (SnO₂) TiO₂, coating (Bb1), coating (Cc1), (SnO₂) TiO₂,
Substrate (S), (SnO₂) TiO₂, coating (Bb1), coating (B1m), coating (Cc1), (SnO₂) TiO₂,
Substrate (S), (SnO₂) TiO₂, coating (Bb1), TiO₂, coating (Cc1), (SnO₂) TiO₂,
Substrate (S), coating (Bb1), coating (Cc1), coating (Bb1), coating (Cc1), or
Substrate (S), (SnO₂) TiO₂, coating (Bb1), coating (Cc1), coating (Bb1), coating (Cc1), (SnO₂) TiO₂,
wherein (SnO₂) TiO₂ is a layer which is prepared by depositing SnO₂ before deposition of TiO₂, and

| | |
|---|---|
| Coating | MOH (100% by weight) → MOH (100-x) % by weight) |
| [(Bb1)] | MOL (0% by weight) → MOL (x % by weight) |
| Coating [(Cc1)] | MOH (100-x % by weight) → MOH (100% by weight) |
| | MOL (x % by weight) → MOL (0% by weight) |
| coating (B1m) | 100-x % by weight MOL and x % by weight MOH |
| coating (B1H) | MOH. |

9. The pigment according to claim 4, wherein the pigment has one of the following layer structures:
Substrate (S), coating (Bb2), coating (Cc2),
Substrate (S), coating (Bb2), coating (B1H), coating (Cc2),
Substrate (S), coating (Bb2), coating (B1m), coating (Cc2),
Substrate (S), (SnO₂) TiO₂, coating (Bb2), coating (Cc2), (SnO₂) TiO₂,
Substrate (S), (SnO₂) TiO₂, coating (Bb2), coating (B1H), coating (Cc2), (SnO₂) TiO₂,
Substrate (S), (SnO₂) TiO₂, coating (Bb2), coating (B1H), coating (Cc2), (SnO₂) TiO₂,
Substrate (S), coating (Bb2), coating (Cc2), coating (Bb2), coating (Cc2), or
Substrate (S), (SnO₂) TiO₂, coating (Bb2), coating (Cc2), coating (Bb2), coating (Cc2), (SnO₂) TiO₂,
wherein (SnO₂) TiO₂ is a layer which is prepared by depositing SnO₂ before deposition of TiO₂, and

| | |
|---|---|
| Coating | MOH (100-x % by weight) → MOH (100) % by weight) |
| [(Bb2)] | MOL (x % by weight) → MOL (0% by weight) |
| Coating [(Cc2)] | MOH (100% by weight) → MOH (100-x % by weight) |
| | MOL (0% by weight) → MOL (x % by weight) |
| coating (B1m) | 100-x % by weight MOL and x % by weight MOH |
| coating (B1H) | MOH. |

10. The pigment according to claim 5, wherein the pigment has one of the following layer structures:
Substrate (S), coating (Bb1), coating (Cc2),
Substrate (S), coating (Bb1), coating (B1m), coating (Cc2),
Substrate (S), coating (Bb1), coating (B1H), coating (Cc2),
Substrate (S), (SnO₂) TiO₂, coating (Bb1), coating (Cc2), Al₂O₃,
Substrate (S), (SnO₂) TiO₂, coating (Bb1), coating (B1m), coating (Cc2), Al₂O₃,
Substrate (S), (SnO₂) TiO₂, coating (Bb1), coating (B1H), coating (Cc2), Al₂O₃,
Substrate (S), coating (Bb1), coating (Cc2), coating (Bb1), coating (Cc2), or
Substrate (S), (SnO₂) TiO₂, coating (Bb1), coating (Cc2), coating (Bb1), coating (Cc2), Al₂O₃,
wherein (SnO₂) TiO₂ is a layer which is prepared by depositing SnO₂ before deposition of TiO₂, and

| | |
|---|---|
| Coating | MOH (100% by weight) → MOH (100-x) % by weight) |
| [(Bb1)] | MOL (0% by weight) → MOL (x % by weight) |
| Coating [(Cc2)] | MOH (100% by weight) → MOH (100-x % by weight) |
| | MOL (0% by weight) → MOL (x % by weight) |
| coating (B1m) | 100-x % by weight MOL and x % by weight MOH |
| coating (B1H) | MOH. |

11. The pigment according to claim 6, wherein the pigment has one of the following layer structures:
Substrate (S), coating (Bb2), coating (Cc2′),
Substrate (S), coating (Bb2), coating (B1m), coating (Cc2′),
Substrate (S), coating (Bb2), coating (B1 H), coating (Cc2′),
Substrate (S), (SnO₂) TiO₂, coating (Bb2), coating (Cc2′), (SnO₂) TiO₂,
Substrate (S), (SnO₂) TiO₂, coating (Bb2), coating (B1m), coating (Cc2′), (SnO₂) TiO₂,
Substrate (S), (SnO₂) TiO₂, coating (Bb2), coating (B1H), coating (Cc2′), (SnO₂) TiO₂,
Substrate (S), coating (Bb2), coating (Cc2′), coating (Bb2), coating (Cc2′), or
Substrate (S), (SnO₂) TiO₂, coating (Bb2), coating (Cc2′), coating (Bb2), coating (Cc2′), (SnO₂) TiO₂.
wherein (SnO₂) TiO₂ is a layer which is prepared by depositing SnO₂ before deposition of TiO₂, and

| | |
|---|---|
| Coating | MOH (100-x % by weight) → MOH (100) % by weight) |
| [(Bb2)] | MOL (x % by weight) → MOL (0% by weight) |
| Coating | MOH (100-x % by weight) → MOH (100% by weight) |
| [(Cc2′)] | MOL (x % by weight) → MOL (0% by weight) |
| coating (B1m) | 100-x % by weight MOL and x % by weight MOH |
| coating (B1H) | MOH. |

12. (canceled)

13. Paints, printing inks, plastics, cosmetics, ceramics and glass, which are pigmented with a pigment according to claim 1.

14. A process for the preparation of pigments, comprising
(b′) adding a preparation comprising a water-soluble metal compound (MOH′) and distilled water (preparation (A)) slowly while keeping the pH constant by continuous addition of 1M NaOH solution to a suspension of the material being coated, which suspension has been heated to about 50-100° C., wherein the amount of MOH′ is controlled in such a manner, that a coating results, wherein the amount of MOH varies (continuously), and
(b″) simultaneously adding a preparation comprising a water-soluble metal compound (MOL′) and distilled water (preparation (B)) to the suspension, wherein the amount of MOL′ is controlled in such a manner, that a coating results, wherein the amount of MOL varies (continuously), and optionally
(c′) adding a preparation comprising a water-soluble metal compound (MOH′) and distilled water (preparation (A)) slowly while keeping the pH constant by continuous addition of 1M NaOH solution to a suspension of the material being coated, which suspension has been heated to about 50-100° C., wherein the amount of MOH′ is controlled in such a manner, that a coating results, wherein the amount of MOH varies (continuously), and
(c″) simultaneously adding a preparation comprising a water-soluble metal compound (MOL′) and distilled water (preparation (B)) to the suspension, wherein the amount of MOL′ is controlled in such a manner, that a coating results, wherein the amount of MOL varies (continuously).

15. The pigment according to claim 2, wherein
MOH is TiO₂ and MOL is ZrO₂,
MOH is TiO₂ and MOL is MgO,
MOH is TiO₂ and MOL is Al₂O₃, or
MOH is TiO₂ and MOL is SiO₂.
